(19) United States
(12) Patent Application Publication
(10) Pub. No.: US 2009/0154422 A1
(43) Pub. Date: Jun. 18, 2009

(54) METHOD OF PROVIDING SEAMLESS QOS GUARANTEES IN INTERNET PROTOCOL (IP) NETWORK WHEN IP-BASED MOBILITY SERVICE IS PROVIDED

(75) Inventors: No-ik Park, Seoul (KR); Soon-seok Lee, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/203,558

(22) Filed: Sep. 3, 2008

(30) Foreign Application Priority Data
Dec. 18, 2007 (KR) 10-2007-0133346

(51) Int. Cl. H04Q 7/00

(52) U.S. Cl. 370/331

(57) ABSTRACT

Provided is a method of providing an Internet Protocol (IP)-based mobility service, particularly, a method of providing seamless quality of service (QoS) guarantees when an IP-based mobile service is provided. The seamless QoS management method includes: a method of providing seamless QoS guarantees when an Internet Protocol (IP)-based mobility service is provided, including: determining whether a terminal is newly registered in a network connecting unit; and providing QoS information of the newly registered terminal to the network connecting unit. Therefore, a user can successively receive a Service Level Agreement (SLA)-based service for which he or she subscribes, while moving to other places.

### CROSS REFERENCE TO RELATED APPLICATIONS

This application claims priority from Korean Patent Application No. 10-2007-0133346, filed on Dec. 18, 2007, the disclosure of which is incorporated herein in its entirety by reference.

### BACKGROUND OF THE INVENTION

1. Field of the Invention

The present invention relates to a method of providing an IP-based mobility service, and more particularly, to a method of providing seamless QoS guarantees when an Internet Protocol (IP)-based mobile service is provided.

This work was supported by the IT R&D program of Ministry of Information and Communication (MIC)/Institute for Information Technology Advancement (IITA) [2007-S-013-01, R&D on all IPv6 based Fixed-Mobile convergence networking technology].

2. Description of the Related Art

Recently, many users are using a network service such as the Internet while they are moving as well as when they stay in a predetermined region. Accordingly, in a next-generation network (NGN), a service of proving IP mobility is important. Accordingly, development of various techniques for providing IP mobility is needed.

Conventionally, a method of providing IP mobility based on a mobile IP (MIP) of Internet Engineering Task Force (IETF) has been mainly used, however, the method could not be applied practically due to a limitation in the MIP.

Also, no method for providing seamlessly QoS guarantees of a service which is presently used when a user and a terminal are moving has been developed.

A terminal has a permanent IP address (based on IPv6) not participating in data transmission, and a transport IP address (based on IPv4 or IPv6) participating in actual data transmission. The permanent IP address is used as an identifier (ID) through which the location of the terminal is registered and the terminal is authenticated. Actual data transmission is performed using the transport IP address. If a network connecting apparatus is changed when the terminal is moved, a network transmission apparatus assigns a new transport IP address to the terminal. An IP mobility control apparatus binds and stores the permanent IP address and transport IP address of the terminal, obtains location information of the terminal using the stored information, and performs mobile control for seamlessly proving a service based on the location information.

### SUMMARY OF THE INVENTION

The present invention provides a method for providing seamless QoS guarantees for a service which is currently provided, even if a network connecting apparatus is changed when a subscriber or a terminal which is using the service is moving.

According to an aspect of the present invention, there is provided a method of providing seamless quality of service (QoS) guarantees, which is performed by a network control unit to control a network connecting unit for connecting a terminal to a service network, when an Internet Protocol (IP)-based mobility service is provided, the method including: when a terminal performs handover, recognizing that a network connecting unit in which the terminal has been registered is changed to a different network connecting unit; and providing QoS information of the terminal to the different network connecting unit.

The recognizing includes recognizing that the network connecting unit in which the terminal has been registered is changed to the different network connecting unit, by acquiring a transport IP address of the terminal and the QoS information of the terminal, which is transmitted from a network control unit. The providing of the QoS information includes transmitting the QoS information of the terminal to the different network connecting unit using the transport IP address of the terminal.

The method of providing seamless quality of service (QoS) guarantees includes: acquiring a permanent IP address of the terminal and the transport IP address of the terminal and requesting the QoS information of the terminal using the permanent IP address of the terminal; acquiring the QoS information of the terminal in response to the request; and transmitting the QoS information of the terminal to the different network connecting unit using the transport IP address of the terminal.

Therefore, a user can successively receive a Service Level Agreement (SLA)-based service for which he or she subscribes, while moving to other places.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram of a system for providing seamless quality of service (QoS) guarantees, according to an embodiment of the present invention;

FIG. 2 is a flowchart of a method of providing seamless QoS guarantees, according to an embodiment of the present invention; and

FIG. 3 shows data flow of a method of providing seamless QoS guarantees according to an embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

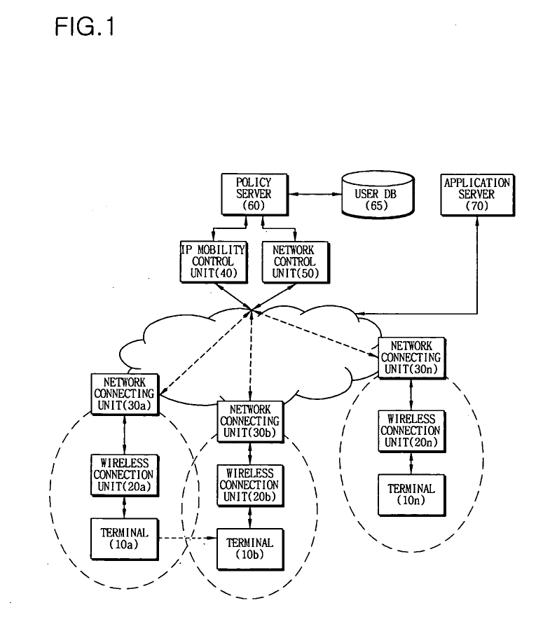

FIG. 1 is a block diagram of a system for providing seamless quality of service (QoS) guarantees, according to an embodiment of the present invention.

As illustrated in FIG. 1, the seamless QoS guarantee system includes a plurality of subsets including a plurality of terminals 10a, 10b, . . . , 10n and a plurality of wireless connection units 20a, 20b, . . . , 20n; a plurality of network connecting units 30a, 30b, . . . , 30n for connecting the respective subnets to a service network; a network control unit 50 for controlling the service network; an IP mobility control unit 40 for controlling IP mobility of the terminals 10a, 10b, . . . , 10n; and a policy server 60 including a user database (DB) 65 for storing policy information of the terminals 10a, 10b, . . . , 10n and user QoS information.

The terminals 10a, 10b, . . . , 10n may be communication terminals, such as Personal Digital Assistants (PDAs), and notebooks, which use IP addresses as a Identifier. The wireless connection units 20a, 20b, and 20n may be access points for controlling an access network. The terminals 10a, 10b, . . . , 10n can be connected to the network connecting units 30a, 30b, . . . , 30n through the wireless connection units 20a, 20b, . . . , 20n.

The network connecting units 30a, 30b, . . . , 30n are used to connect the terminals 10a, 10b, . . . , 10n to a service server, and may be routers. The terminals 10a, 10b, . . . , 10n are connected to a service network through the wireless connection units 20a, 20b, . . . , 20n and the network connecting units 30a, 30b, . . . , 30n, to thus receive a service. Here, various services can be provided to the terminals 10a, 10b, . . . , 10n, depending on functions of an application server 70 connected to the service network. Particularly, the service provided through the service network may be a client/server type service which is provided between the terminals 10a, 10b, . . . , 10n and the application server 70, or a point-to-point type service which is provided between different terminals 10a, 10b, . . . , 10n.

The IP mobility control unit 40 performs control related to IP mobility of the terminals 10a, 10b, . . . , 10n which are connected to the service network through the network connecting units 30a, 30b, . . . , 30n.

Then, the network control unit 50 controls the network connecting units 30a, 30b, . . . , 30n based on mobility policy information of terminals which is acquired from the policy server 60.

Here, the network control unit 50 acquires service subscriber information, service QoS information, etc., from the policy server 60, and allows the network connecting units 30a, 30b, . . . , 30n to control transmission of packet data according to Service Level Agreement (SLA) of the corresponding service subscriber.

If the terminals 10a, 10b, . . . , 10n, which are using the service, for example, are moving between the subnets, the network control unit 50 provides context information about the corresponding service of the terminals 10a, 10b, . . . , 10n, to the network connecting units 30a, 30b, . . . , 30n to which the terminals 10a, 10b, . . . , 10n are newly connected, when the terminals 10a, 10b, . . . , 10n perform handover. For example, the terminal 10a, which is using the service through the network connecting unit 30a, performs handover to move the location of the terminal 10b. In this case, the network control unit 50 provides context information about the corresponding service of the terminal 10a to the network connecting unit 30b to which the terminal 10a is newly connected

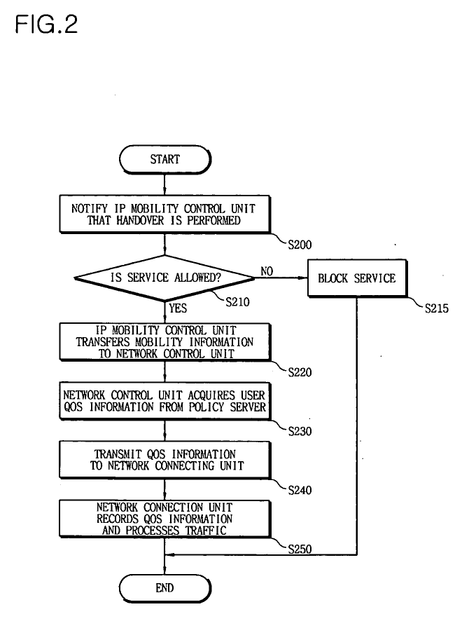

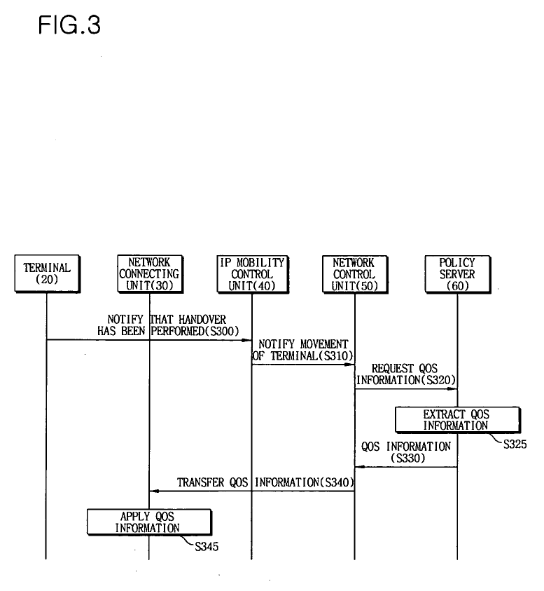

Hereinafter, a method for providing seamless QoS guarantees will be described with reference to FIGS. 2 and 3.

FIG. 2 is a flowchart of a method for providing seamless QoS guarantees, according to an embodiment of the present invention.

Referring to FIGS. 1 and 2, when the terminal 10 performs handover, the terminal 10 transmits to the IP mobility control unit 40 a handover notification for notifying that handover is performed (operation S200). Here, the term “handover” means newly registering the terminal 10 in a network connecting unit 30 of a different subnet when the terminal 10 is moved to the different subnet.

Here, the terminal 10 transfers a permanent IP address and a transport IP address of the terminal 10 to the IP mobility control unit 40 when the terminal 10 performs handover. The IP mobility control unit 40 determines whether a service is allowed to the terminal 10 on the basis of the permanent IP address and transport IP address of the terminal 10 (operation S210). If the service is not allowed to the terminal 10 or to a user of the terminal, the service is blocked (operation s215). If the service is allowed to the terminal 10, the IP mobility control unit 40 transfers mobility information including the permanent IP address, previous transport IP address, and newly received transport IP address of the terminal 10 to the network control unit 50 (operation S220). The network control unit 50 requests user QoS information to a policy server 60 on the basis of the mobility information of the terminal 10. Then, the network control unit 50 acquires the user QoS information from the policy server 60 (operation S230), and transfers the user QoS information to the network connecting unit 30 (operation S240). Then, the network connecting unit 30 stores the user QoS information, processes traffic data according to the QoS information, and provides the result of the processing to the terminal 10.

FIG. 3 shows data flow of a method for providing seamless QoS guarantees, according to an embodiment of the present invention.

A terminal 10 which is connected to a different network connecting unit 30 by handover transmits to an IP mobility control unit 40 a handover notification for notifying that handover is performed (operation S300). Here, the handover notification includes a permanent IP address of the terminal 10, and a transport IP address of the terminal 10 changed by the handover.

Here, the IP mobility control unit 40 stores the permanent IP address of the terminal 10, and a transport IP address which has been assigned by a home network and has been used by the terminal 10 before the handover is performed. If the handover notification is received from the terminal 10, the mobility control unit 40 updates the transport IP address of the terminal 10 to a newly changed transport IP address on the basis of the permanent IP address of the terminal 10.

Thereafter, the IP mobility control unit 40 determines whether a service subscriber and the terminal 10 has been moved, and notifies the network control unit 50 of the movement of the terminal 10 (operation S310). That is, the IP mobility control unit 40 transmits the permanent IP address of the terminal 10, the previous transport IP address of the terminal 10, and the newly changed transport IP address to the network control unit 50, thereby notifying the network control unit 50 of the movement of the terminal 10. At this time, the user QoS information can also be transmitted to the network control unit 50. That is, if the network control unit 50 receives both address information of the terminal 10 and user QoS information from the IP mobility control unit 40, the network control unit 50 can perform network resource control on the basis of the address information and QoS information.

Meanwhile, if the network control unit 50 receives only address information of the terminal 10 from the IP mobility control unit 40, the network control unit 50 requests QoS information of the terminal 10 to the policy server 60 (operation S320). The request of the QoS information may include the permanent IP address of the terminal 10. The policy server 60 can obtain user QoS information of the terminal 10 with reference to user DB. The user QoS information and the permanent IP address of the terminal 10 are bound and stored in the user DB. The policy server 60 extracts the user QoS information from the user DB on the basis of the permanent IP address of the terminal 10 (operation S325), and transfers the user QoS information to the network control unit 50 (operation S330).

The network control unit 50 controls network resources using the user QoS information received from the policy server 60. The network control unit 50 transfers the user QoS information to a network connecting unit 30 (operation S340). The network connecting unit 30 stores the user QoS information, and processes traffic transmitted to the terminal 10 on the basis of the user QoS information (operation S345).

Meanwhile, the method of providing seamless QoS guarantees may be written as a computer program. Also, the program may be stored in computer readable media, and read and executed by a computer. The computer readable media may be a magnetic recording medium, an optical recording medium, etc.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of providing seamless quality of service (QoS) guarantees, which is performed by a network control unit to control a network connecting unit for connecting a terminal to a service network, when an Internet Protocol (IP)-based mobility service is provided, comprising:
when a terminal performs handover, recognizing that a network connecting unit in which the terminal has been registered is changed to a different network connecting unit; and
providing QoS information of the terminal to the different network connecting unit.

2. The method of claim 1, wherein the recognizing comprises recognizing that the network connecting unit in which the terminal has been registered is changed to the different network connecting unit, by acquiring a transport IP address of the terminal and the QoS information of the terminal, from an IP mobility control unit.

3. The method of claim 2, wherein the providing of the QoS information comprises transmitting the QoS information of the terminal to the different network connecting unit using the transport IP address of the terminal.

4. The method of claim 1, wherein the recognizing comprises:
determining whether the terminal is newly registered, by acquiring IP address information of the terminal;
requesting the QoS information of the terminal using the IP address information of the terminal; and
acquiring the QoS information of the terminal in response to the request.

5. The method of claim 4, wherein the IP address information includes a permanent IP address and a transport IP address of the terminal.

6. The method of claim 4, wherein the requesting of the QoS information of the terminal comprises, in an IP mobility control unit, receiving a handover notification from the terminal, and transmitting the IP address information of the terminal which has performed the handover to the network control unit.

7. The method of claim 4, wherein the requesting of the QoS information of the terminal comprises, in the network control unit, requesting the QoS information of the terminal to a policy server.

8. The method of claim 3, further comprising:
receiving a request for acquiring user QoS information including a permanent IP address of the terminal from a network control unit;
extracting the user QoS information of the terminal from a predetermined database with reference to the permanent IP address of the terminal; and
providing the user QoS information to the network control unit.

9. The method of claim 3, further comprising:
in the network connecting unit, receiving the QoS information of the terminal; and
transmitting a data packet to the terminal on the basis of the QoS information of the terminal.

10. The method of claim 4, further comprising:
in the network connecting unit, receiving the QoS information of the terminal; and
transmitting a data packet to the terminal using the QoS information of the terminal.
